(19) United States
(12) Patent Application Publication
(10) Pub. No.: US 2019/0300240 A1
(43) Pub. Date: Oct. 3, 2019

(54) FLUID CONTAINMENT SYSTEM

(71) Applicant: ELECTROLUX HOME PRODUCTS, INC., Charlotte, NC (US)

(72) Inventors: Erin Smith Wright, Indian Trail, NC (US); Brian Roderman, Plano, TX (US); David Singer, Austin, TX (US); Justin Pendleton, The Colony, TX (US); Sara Roueche Dulski, Huntersville, NC (US); Kevin Shin, Austin, TX (US)

(73) Assignee: ELECTROLUX HOME PRODUCTS, INC., Charlotte, NC (US)

(21) Appl. No.: 16/369,304

(22) Filed: Mar. 29, 2019

Related U.S. Application Data
(60) Provisional application No. 62/650,024, filed on Mar. 29, 2018.

(51) Int. Cl. B65D 25/24; B01D 35/027; B67D 3/00

(52) U.S. Cl. CPC B65D 25/24; B67D 3/009; B01D 35/027

(57) ABSTRACT

An exemplary fluid containment system may include a fluid receptacle comprising a receptacle cavity and a receptacle opening. Typically, the fluid receptacle is structured for receiving fluid via the receptacle opening. The fluid containment system further comprises a fluid control component structured to be operatively coupled to the fluid receptacle for controlling fluid flow into the fluid receptacle through the receptacle opening. The fluid receptacle may further comprise a base projection extending from an end of the fluid receptacle structured for positioning and stabilizing the fluid receptacle within a drain recess. The fluid containment system further comprises a fluid container structured for receiving fluid and structured to be positioned within the receptacle cavity of the fluid receptacle.

### CROSS-REFERENCE TO PRIORITY APPLICATION

This application claims priority to and the benefit of U.S. Provisional Patent Application Ser. No. 62/650,024 entitled “Fluid Containment System” filed on Mar. 29, 2018, which is hereby incorporated by reference in its entirety.

### FIELD OF THE INVENTION

The present invention relates to containment and storage systems for fluids and, more specifically, to a system structured for containment, storage and/or transportation of fluids such as viscous liquids, emulsions, semi-solids, solutions, or a combination thereof.

### BRIEF SUMMARY OF THE INVENTION

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The invention provides apparatuses and methods of assembly and use of a fluid containment system. In particular, in some embodiments of the invention, the fluid containment system of the present invention includes a fluid receptacle comprising a receptacle cavity and a receptacle opening. Typically, the fluid receptacle is structured for receiving fluid via the receptacle opening. The fluid receptacle further comprises a base projection extending from a second end of the fluid receptacle structured for positioning and stabilizing the fluid receptacle within a drain recess such that at least a portion of an outer surface of the base projection is configured to be enclosed by the drain recess. The fluid containment system further comprises a fluid control component structured to be operatively coupled to the fluid receptacle for controlling fluid flow into the fluid receptacle through the receptacle opening.

In some embodiments or in combination with any of the previous embodiments, the base projection is configured such that when the base projection is positioned in the drain recess: a first portion of the outer surface of the base projection is configured to operatively contact an adjacent inner surface of the drain recess; and a second portion of the outer surface extending from the first portion of the outer surface is configured to not contact an adjacent inner surface of the drain recess.

In some embodiments or in combination with any of the previous embodiments, the base projection defines a major axis length at the first portion of the outer surface such that the major axis length is substantially equal to a diameter of the drain recess. Moreover, the base projection defines a minor axis length at the second portion of the outer surface such that the minor axis length is less than the diameter of the drain recess. Here, the major axis length and the diameter of the drain recess maybe in the range of 1.5 inches to 4.5 inches.

In some embodiments or in combination with any of the previous embodiments, a first portion of the outer surface of the base projection comprises a first curvature that matches a curvature of an adjacent inner surface of the drain recess when the base projection is positioned within the drain recess. Here, typically, a radius of the first curvature is substantially equal to one half of a diameter of the drain recess.

In some embodiments or in combination with any of the previous embodiments, the first portion of the outer surface defines a sector angle span in the range of 30 degrees to 150 degrees.

In some embodiments or in combination with any of the previous embodiments, the first portion of the outer surface defines a sector angle span in the range of 60 degrees to 80 degrees.

In some embodiments or in combination with any of the previous embodiments, the fluid containment system further comprises a containment system cover structured to be operatively coupled to a first end of the fluid control component.

In some embodiments or in combination with any of the previous embodiments, the fluid containment system further comprises a fluid container structured for receiving fluid and structured to be positioned within the receptacle cavity of the fluid receptacle.

In some embodiments or in combination with any of the previous embodiments, the container cavity of the fluid container comprises a lesser volume than the receptacle cavity of the fluid receptacle.

In some embodiments or in combination with any of the previous embodiments, the fluid control component defines a first end and an opposite second end. Moreover, the fluid control component further comprises a fluid guide portion extending between the first end and the second end; and an outer securing portion extending from the first end. Typically, the fluid control component is structured to receive an end portion of the fluid receptacle between the fluid guide portion and the outer securing portion, wherein the end portion is proximate the receptacle opening of the fluid receptacle.

In some embodiments or in combination with any of the previous embodiments, the fluid guide portion defines a first circumference length at the first end (also referred to as a top end) and a second circumference length at the second end such that the first circumferential length is greater than the second circumference length. Moreover the outer securing portion defines a third circumference length at a lower end such that the third circumference length is greater than the second circumference length. The fluid guide portion is structured such that (i) at least a portion of the fluid guide portion is received within the receptacle cavity of the fluid receptacle and (ii) outer securing portion is positioned proximate an outer surface of the fluid receptacle when the fluid control component is operatively coupled to the fluid receptacle.

In some embodiments or in combination with any of the previous embodiments, the fluid guide portion is structured to secure a fluid container within the receptacle cavity of the fluid receptacle based on positioning an end portion of the fluid container between the fluid guide portion and an inner surface of the fluid receptacle when the fluid control component is operatively coupled to the fluid receptacle.

In some embodiments or in combination with any of the previous embodiments, the fluid is a viscous fluid.

In some embodiments, the invention provides apparatuses and methods of assembly and use of a fluid container for a fluid containment system, such as the fluid containment system described above. In particular, the fluid container comprises a container cavity structured for receiving fluid via a container opening. The fluid container is structured to be positioned within a receptacle cavity of a fluid receptacle of the fluid containment system.

In some embodiments or in combination with any of the previous embodiments, the fluid container is flexible.

In some embodiments or in combination with any of the previous embodiments, the fluid container comprises an interior thermal resistant lining. In some embodiments or in combination with any of the previous embodiments, the fluid container comprises an exterior paper lining.

In some embodiments or in combination with any of the previous embodiments, the fluid control component comprises a filter structure.

Embodiments of the invention are also directed to a method for fluid containment. Typically, the method begins with providing (i) a fluid receptacle, wherein the fluid receptacle comprises a receptacle cavity, a receptacle opening, and a base stabilizer structured for positioning and stabilizing the fluid receptacle within a drain recess, and (ii) a fluid control component structured to be operatively coupled to the fluid receptacle, wherein the fluid control component is structured for controlling fluid flow into the fluid receptacle through the receptacle opening. Next, the method involves, operatively coupling the fluid control component and the fluid receptacle to form a receptacle assembly and positioning the receptacle assembly at a drain recess such that at least a portion of an outer surface of the base projection is configured to be enclosed by the drain recess. Moreover, the method involves transferring a fluid into the receptacle cavity of the fluid receptacle through the fluid control component. The method may also involve operatively coupling a containment system cover to a first end of the fluid control component.

In some embodiments or in combination with any of the previous embodiments, positioning the receptacle assembly at a drain recess further comprises: positioning a first portion of the outer surface of the base projection to operatively contact an adjacent inner surface of the drain recess; and positioning a second portion of the outer surface extending from the first portion of the outer surface to not contact an adjacent inner surface of the drain recess.

In some embodiments or in combination with any of the previous embodiments, the fluid control component comprises a fluid guide portion extending between the first end and an opposite second end, and an outer securing portion extending from the first end, wherein operatively coupling the fluid control component and the fluid receptacle further comprises: positioning an end portion of the fluid receptacle between the fluid guide portion and the outer securing portion such that (i) at least a portion of the fluid guide portion is received within the receptacle cavity of the fluid receptacle, and (ii) the outer securing portion is positioned proximate an outer surface of the fluid receptacle.

In some embodiments or in combination with any of the previous embodiments, the method further comprises securing a fluid container within the receptacle cavity of the fluid receptacle based on positioning an end portion of the fluid container between the fluid guide portion and an inner surface of the fluid receptacle.

### BRIEF DESCRIPTION OF THE DRAWINGS

The features and functions of the invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 illustrates a perspective view 100 of a fluid containment system, in accordance with some embodiments of the invention;

FIG. 2A illustrates a perspective view 200A of a fluid receptacle, in accordance with some embodiments of the invention;

FIG. 2B illustrates a top view 200B of the fluid receptacle illustrated in FIG. 2A, in accordance with some embodiments of the invention;

FIG. 2C illustrates a bottom view 200C of the fluid receptacle illustrated in FIG. 2A, in accordance with some embodiments of the invention;

FIG. 2D illustrates a schematic bottom view 200D of the fluid receptacle illustrated in FIG. 2A, in accordance with some embodiments of the invention;

FIG. 3A illustrates a perspective view 300A of a flow control component, in accordance with some embodiments of the invention;

FIG. 3B illustrates a top view 300B of the flow control component illustrated in FIG. 3A, in accordance with some embodiments of the invention;

FIG. 3C illustrates a bottom view 300C of the flow control component illustrated in FIG. 3A, in accordance with some embodiments of the invention;

FIG. 3D illustrates a sectional detail view 300D of the flow control component illustrated in FIG. 3C, in accordance with some embodiments of the invention;

FIG. 4A illustrates a perspective view 400A of a containment system cover, in accordance with some embodiments of the invention;

FIG. 4B illustrates a bottom view 400B of the containment system cover illustrated in FIG. 4A, in accordance with some embodiments of the invention;

FIG. 5A illustrates a perspective view 500A of a fluid container, in accordance with some embodiments of the invention;

FIG. 5B illustrates a top view 500B of the fluid container illustrated in FIG. 5A, in accordance with some embodiments of the invention;

FIG. 6A illustrates a front view 600A of a fluid containment system assembly, in accordance with some embodiments of the invention;

FIG. 6B illustrates a top perspective view 600B of a fluid containment system assembly, in accordance with some embodiments of the invention;

FIG. 6C illustrates a high level process flow 600C for a method for fluid containment, in accordance with some embodiments of the invention;

FIG. 7 illustrates a perspective view 700 of a fluid containment system, in accordance with some embodiments of the invention;

FIG. 8A illustrates a perspective view 800A of a fluid receptacle, in accordance with some embodiments of the invention;

FIG. 8B illustrates a side sectional view 800B of the fluid receptacle illustrated in FIG. 8A, in accordance with some embodiments of the invention;

FIG. 8C illustrates a bottom sectional view 800C of the fluid receptacle illustrated in FIG. 8A, in accordance with some embodiments of the invention;

FIG. 8D illustrates a schematic bottom view 800D of the fluid receptacle illustrated in FIG. 8A, in accordance with some embodiments of the invention;

FIG. 9A illustrates a top perspective view 900A of a flow control component, in accordance with some embodiments of the invention;

FIG. 9B illustrates a front view 900B of the flow control component illustrated in FIG. 9A, in accordance with some embodiments of the invention;

FIG. 9C illustrates a bottom perspective view 900C of the flow control component illustrated in FIG. 9A, in accordance with some embodiments of the invention;

FIG. 9D illustrates a sectional detail view 900D of an assembly of the flow control component illustrated in FIG. 9A and the fluid receptacle illustrated in FIG. 8A, in accordance with some embodiments of the invention;

FIG. 10A illustrates a perspective view 1000A of a containment system cover, in accordance with some embodiments of the invention; and

FIG. 10B illustrates a sectional view 1000B of the fluid containment system assembly illustrated in FIG. 7, in accordance with some embodiments of the invention.

### DETAILED DESCRIPTION OF THE INVENTION

The present invention now will be described more fully hereinafter with reference to the accompanying drawings, in which some, but not all embodiments of the invention are shown. This invention may be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Certain fluids such as viscous liquids, emulsions, semi-solids, solutions, or a combination thereof (e.g., oils, grease, fat, shortening, and/or the like) often at least partially solidify on cooling to a certain temperature (e.g., room temperature). Hence, such fluids are not typically compatible with disposal via a drain (e.g., sink drain) because their disposal within a drain may impede or block flow of fluid within the piping of the drain due to viscosity of the fluids, solidification of the fluids upon cooling, immiscibility of the fluid with water, and other factors. There is a need for a containment, storage and disposal system for fluids which are not typically compatible with disposal via a drain (e.g., sink drain). Moreover, there is a need for a system that allows for transport and reuse of the fluids.

The present invention relates to containment and storage systems for fluids and, more specifically, to a system structured for containment, storage and/or transportation of fluids such as viscous liquids, emulsions, semi-solids, solutions, or a combination thereof. The embodiments of the fluid containment system of the present invention, as will be described in detail below, alleviates the needs identified above, as will be described herein. The functions and features of various embodiments of the fluid containment system are described below. It should be appreciated that these features can be provided separately in fluid containment system or the fluid containment system may have combinations of individual features or may have all of the features. As used herein, the term “fluid” may refer to fluids such as viscous liquids, emulsions, semi-solids, solutions, suspensions, other liquids, or a combination thereof. In some embodiments, the term “fluid” refers to a viscous fluid (e.g., having a viscosity above a predetermined threshold) and may be interchangeable with “grease,” both of which may refer to viscous liquids, emulsions, semi-solids, solutions, suspensions, other liquids, or a combination thereof (e.g., oils, grease, fat, shortening, and/or the like) that often at least partially solidify on cooling to a certain temperature (e.g., room temperature).

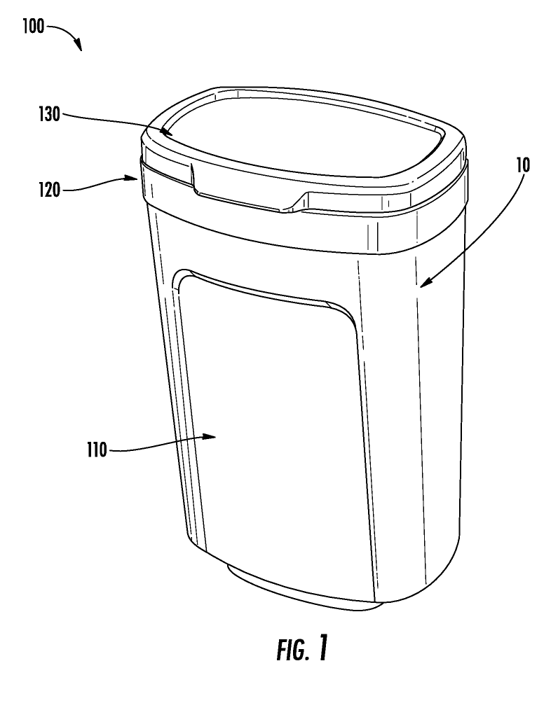

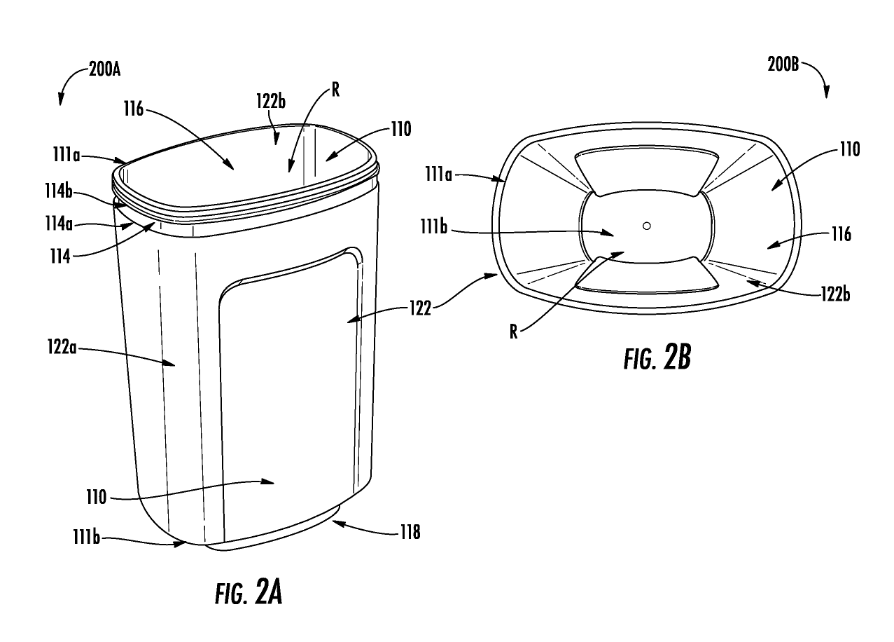

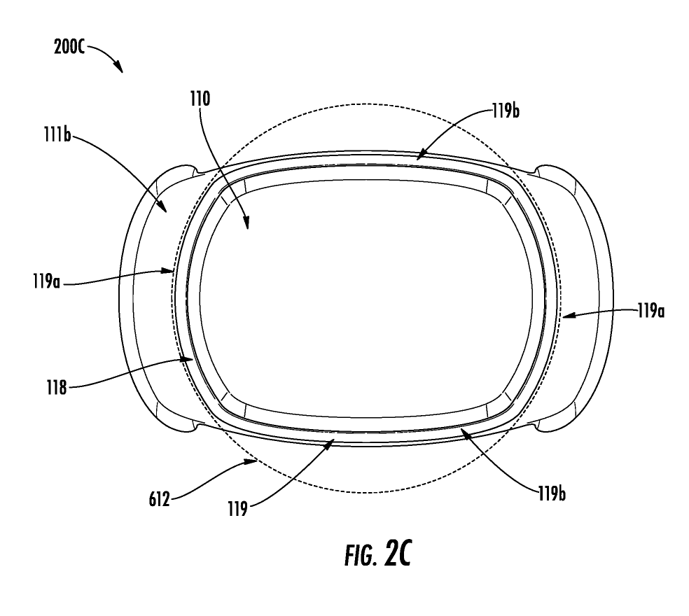

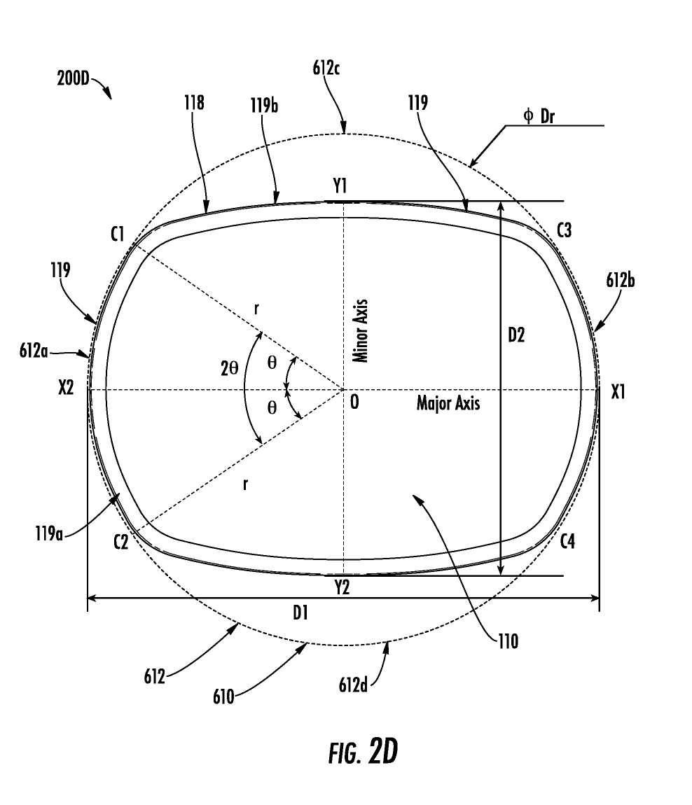

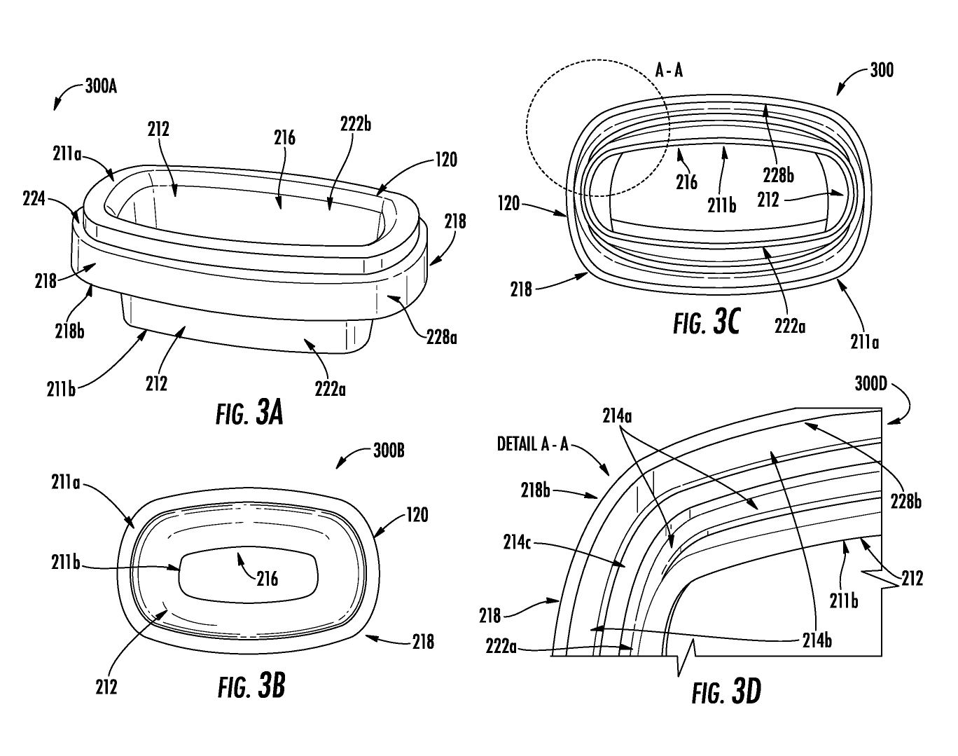

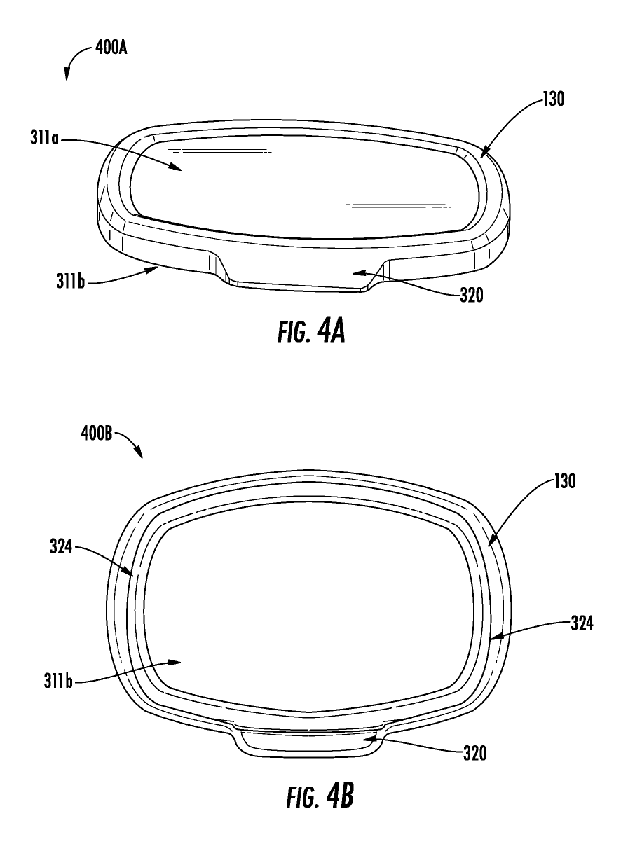

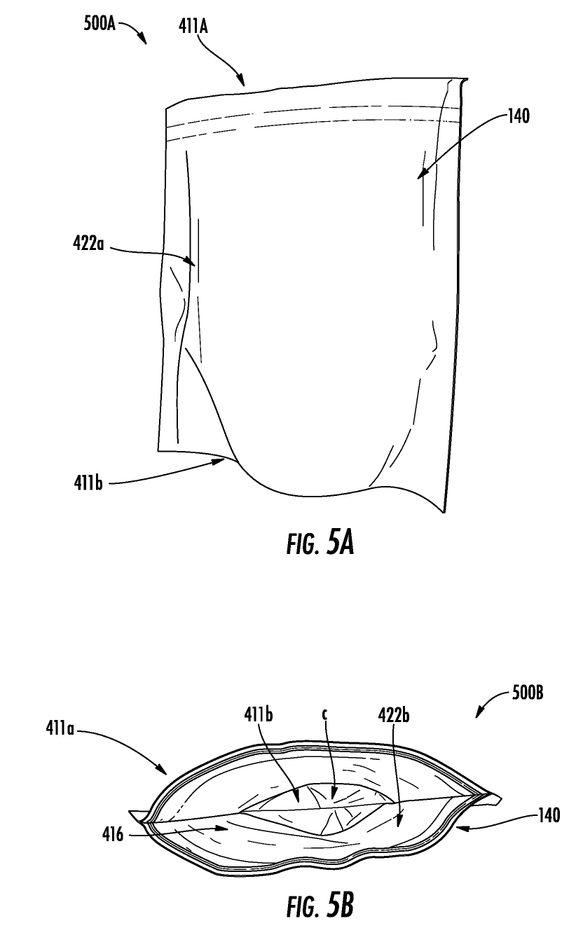

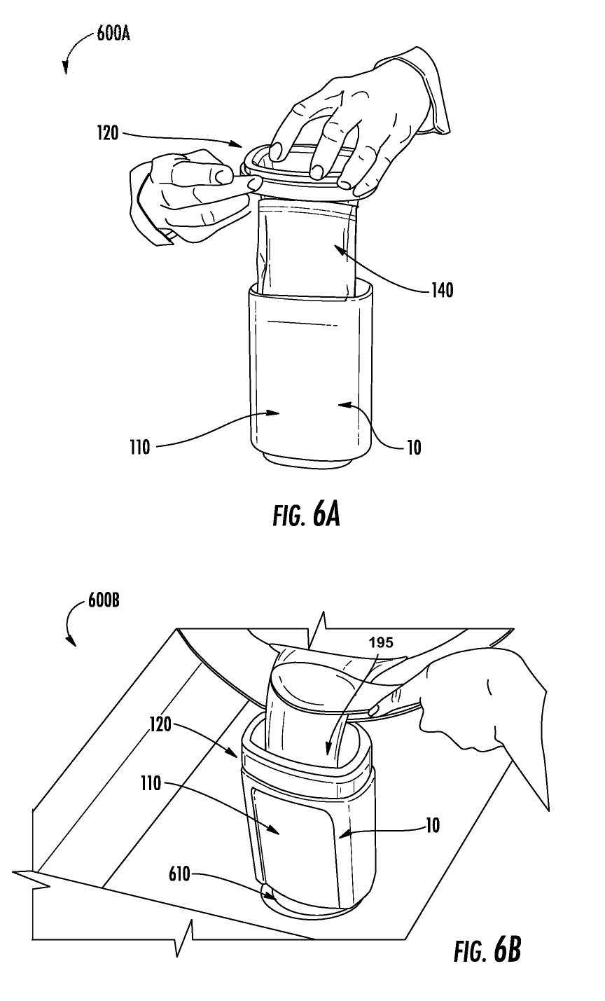

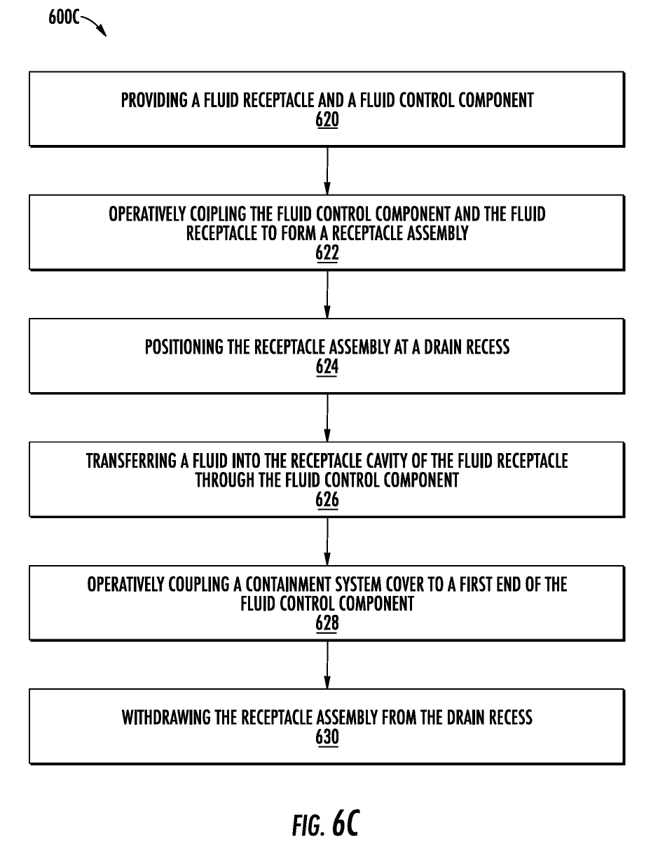

FIG. 1 illustrates a perspective view 100 of a fluid containment system 10, in accordance with some embodiments of the invention. The fluid containment system 10 typically comprises a fluid receptacle 110, a flow control component 120 and a containment system cover 130. In some embodiments, the fluid containment system 10 also comprises a fluid container 140 (illustrated in FIGS. 5A-5B and 6A-6B). The fluid receptacle 110 is typically structured to receive, contain, store and/or transport fluid either directly or via the fluid container 140, as will be described in detail with respect to FIGS. 2A-2D and 6A-6B. Moreover, the fluid receptacle 110 is also configured to securely position the fluid containment system 10 within a drain portion in some embodiments. The fluid control component 120 is structured to be operatively coupled to the fluid receptacle 110 and is further structured to control the direction, channel and/or guide flow of fluid into the fluid receptacle 110, as will be described in detail with respect to FIGS. 3A-3D and 6A-6B. Moreover, in some embodiments, the fluid control component 120 is structured to operatively secure or position the fluid container 140 within the fluid receptacle 110. The containment system cover 130 is structured to be operatively coupled to the fluid control component 120 to securely enclose fluid within the fluid receptacle 110, as will be described with respect to FIGS. 4A-4B and 6A-6B. The fluid container 140 is structured to receive, contain, store and/or transport fluid and structured to be positioned within the fluid receptacle 110. In some embodiments, the fluid container 140 is disposable. The configuration of these components is described below in detail. The fluid containment system 10 can comprise more or fewer components as required for various embodiments.

One or more of the components (e.g., the fluid receptacle 110, fluid control component 120, containment system cover 130 and/or fluid container 140) of the fluid containment system 10 may be manufactured from same or different materials, such as plastics, metals, composites, non-metals, organic materials, and/or the like, or a combination thereof. In some embodiments, the components of the fluid containment system 10, and particularly the fluid receptacle 110 and/or fluid control component 120, may be manufactured from thermal resistant/heat resistant materials that have the thermal resistance and/or are structured to withstand without deforming (e.g., upon exposure to high temperature fluids), temperatures in the range of about 300° F. to 375° F., 350° F. to 480° F., 350° F. to 400° F., 325° F. to 395° F., 250° F. to 380° F., 150° F. to 380° F., 50° F. to 450° F., 100° F. to 480° F., 250° F. to 480° F., and/or 210° F. to 500° F., including, in-between, or overlapping these ranges, and/or temperatures greater than about 100° F., 130° F., 180° F., 210° F., 250° F., 275° F., 310° F., 320° F., 345° F., 350° F., 370° F., 385° F., 400° F., 450° F., 475° F., 500° F., 530° F., 550° F., 600° F., 670° F., or 700° F. Moreover, these thermal resistant/heat resistant materials may be selected from a group comprising heat resistant plastic materials, heat resistant composites, heat resistant polymers, heat resistant metals/alloys, and/or the like. Also, these thermal resistant/heat resistant materials may be food grade.

FIGS. 2A-2D illustrate a fluid receptacle 110, in accordance with some embodiments of the invention. In particular, FIG. 2A illustrates a perspective view 200A of a fluid receptacle 110, in accordance with some embodiments of the invention. FIG. 2B illustrates a top view 200B of the fluid receptacle illustrated in FIG. 2A, in accordance with some embodiments of the invention. FIG. 2C illustrates a bottom view 200C of the fluid receptacle illustrated in FIG. 2A, in accordance with some embodiments of the invention. FIG. 2D illustrates a schematic bottom view 200D of the fluid receptacle illustrated in FIG. 2A, in accordance with some embodiments of the invention.

The fluid receptacle 110 typically comprises a receptacle body 122 having a first end 111a and an opposite second end 111b. Moreover, the receptacle body 122 comprises an outer surface 122a and an opposing inner surface 122b extending between the first end 111a and the second end 111b. The receptacle body 122 comprises an opening 116 at the first end 111a forming a receptacle cavity “R” configured for receiving fluid either directly, receiving fluid within a fluid container 140 and or receiving the fluid container. The receptacle cavity R is at least partially bounded by the inner surface 122b, as illustrated. The receptacle body 122 comprises a receptacle coupling portion 114 proximate the first end 111a. The receptacle coupling portion 114 comprises one or more coupling elements for coupling the fluid receptacle 110 with the fluid control component 120. The one or more coupling elements of the receptacle coupling portion 114 comprise a step coupling portion 114a and a projection coupling portion 114b positioned on the outer surface 122a of the fluid receptacle 110.

The fluid receptacle 110 further comprises a base projection 118 (also referred to as a base stabilizer 118) at the second end 111b, as illustrated by FIGS. 2A and 2C-2D. The base projection 118 typically comprises an oblong cylindrical shape having an outer surface 119 and is structured to position and stabilize the fluid receptacle 110 within a recess, such as a drain portion (illustrated in FIG. 6B). Specifically, in some embodiments, the base projection 118 comprises a projection body having one or more first curved portions 119a, typically having curvature corresponding to a curvature of the recess. In some embodiments the one or more curved portions 119a comprise a curvature of a section of a circle. In some embodiments, typically, the base projection 118 comprises two opposite first curved portions 119a, as illustrated by FIGS. 2C-1D. Here, in some embodiments, the base projection 118 may further comprise one or more bridge portions 119b (also referred to as second portions) extending between the opposite curved portions 119a, as illustrated.

The structure of the base projection 118, vis-à-vis the operatively coupling of the fluid receptacle 110 and a drain recess 610, particularly with respect to FIGS. 2C-2D. The drain recess 610 (illustrated in FIG. 6B) may define an inner surface, typically a circular inner surface 612 having a diameter “Dr,” as illustrated by FIG. 2D. In this regard, the circular inner surface 612 illustrated by FIG. 2D may be associated with a cross section (e.g., a cross section along a plane perpendicular to the axis) of the drain recess 610, with the drain recess 610 in turn generally having a cylindrical shape, conical shape, a stepped-cylindrical shape, or a combination of the foregoing, at least in part. In some embodiments, the diameter Dr of the drain recess 610 may be in the range of about 1.5 inches to 4.5 inches, 1.2 inches to 4.5 inches, 2 inches to 4.5 inches, 2.5 inches to 5.5 inches, 2.5 inches to 4 inches, 2.8 inches to 3.8 inches, and/or the like.

As discussed above, the base projection 118 of the fluid receptacle 110 extends from the second end 111b. Typically, when the fluid receptacle 110 is positioned at the drain recess 610, the at least a portion of the outer surface 119 of the base projection 118 is enclosed by the inner surface 612 of the drain recess 610. Moreover, in the embodiment illustrated in FIGS. 2C and 2D, the outer surface 119 of the base projection 118 is fully enclosed by the inner surface 612 of the drain recess 610 (e.g., when viewed at a cross section along a plane perpendicular to a longitudinal axis of the fluid receptacle 110).

Now referring to FIG. 2D, the base projection 118 typically defines a major axis X1-X2, and a minor axis Y1-Y2 perpendicular to and intersecting the major axis X1-X2 at a center “0”. Typically, the major axis X1-X2 is located at a maxima of the width of the outer surface 119 (e.g., perpendicular distance between points X1 and X2) along the minor axis Y1-Y2, and the minor axis Y1-Y2 is located at a maxima of the thickness of the outer surface 119 (e.g., perpendicular distance between points Y1 and Y2) along the major axis X1-X2. In other words, the major axis X1-X2 defines a maximum width D1 or major axis length D1, and the minor axis defines a maximum thickness D2 or minor axis length D2. Moreover, the major axis length D1 is typically greater than the minor axis length D2.

As illustrated by FIG. 2D, the base projection 118 comprises a first portion 119a that operatively contacts an adjacent portion of the inner surface 612 of the drain recess 610, and a second portion 119b that does not contact an adjacent portion of the inner surface 612. Specifically, the first portion 119a comprising sector arc C1-C2 operatively contacts an adjacent portion 612a of the inner surface 612, while the second portion 119b comprising sector arc C1-C3 does not contact an adjacent portion 612c of the inner surface 612. Similarly, the first portion 119a comprising sector arc C3-C4 operatively contacts an adjacent portion 612b of the inner surface 612, while the second portion 119b comprising sector arc C2-C4 does not contact the adjacent portion 612d of the inner surface 612. As such, the first portion 119a may refer to one or both of the sector arcs C1-C2 and C3-C4, while the second portion 119b may in turn refer to one or both of the sector arcs C1-C3 and C2-C4. That said, it is understood that the first portion 119a and/or the second portion 119b may comprise more or fewer arc sectors each (e.g., 3 or 5 arc sectors each) in other embodiments. Moreover, “operative contact” as used herein may refer to substantial contact (e.g., accounting for tolerances, surface texture, roughness, surface defects, surface patterns, and/or the like) between the first portion 119a and the corresponding adjacent portion of the inner surface 612 such that the base projection 118 positions (i.e., anchors) and stabilizes the fluid receptacle 110 within the drain recess 610 (e.g., in a stable upright manner as illustrated in FIG. 6B). In addition, in some embodiments, “operative contact” may refer to an interference fit (e.g., press fit, etc.) between the first portion 119a and the corresponding adjacent portion of the inner surface 612, while in other embodiments “operative contact” may refer to either a transition fit (e.g., fixed fit, similar fit, tight fit, etc.) or a clearance fit (e.g., location fit, etc.) between the first portion 119a and the corresponding adjacent portion of the inner surface 612, with the first portion 119a being shaped and dimensioned accordingly to provide the corresponding fits.

To facilitate the operative contact, the major axis length D1 at the first portion 119a (i.e., that contacts the inner drain surface 612) is typically substantially equal to the diameter “Dr” of the inner drain surface 612 of the drain recess 610. Here, “substantially equal” may refer to the major axis length D1 and the diameter “Dr” of the inner drain surface 612 being about the same (e.g., the nominal value of the major axis length D1 being equal to the nominal value of the diameter “Dr”), accounting for (i) allowances of the major axis length D1 to provide the desired engineering fit (selected from those listed above) and (ii) tolerances, surface texture, roughness, surface defects, surface pattern and other surface factors of the outer surface 119. In some embodiments, the major axis length D1 may be in the range of about 1.5 inches to 4.5 inches, 1.2 inches to 4.5 inches, 2 inches to 4.5 inches, 2.5 inches to 5.5 inches, 2.5 inches to 4 inches, 2.8 inches to 3.8 inches, and/or the like. Moreover, depending of the type and properties of the engineering fit chosen, the allowances of the major axis length D1 may be in the range of about ±1 mm, ±2 mm, ±3 mm, ±4 mm, ±5 mm, ±6 mm, ±9 mm, and/or the like. Moreover, the minor axis length D2 at the second portion 119b of the outer surface 119 is typically less than the diameter “Dr” of the inner drain surface 612 of the drain recess 610. In particular, the minor axis length D2 may be in the range of about 1 inch to 3 inches, 1.2 inches to 4 inches, 2 inches to 4.5 inches, 2.5 inches to 5 inches, 2.5 inches to 3.5 inches, 2.8 inches to 3.2 inches, and/or the like, with the minor axis length D2 being less than the major axis length D2.

Moreover, the first portion 119a comprises a first curvature that matches a curvature of an adjacent inner surface of the drain recess when the base projection is positioned within the drain recess. In this regard, the sector arc C1-C2 of the first portion 119a comprises a curvature with a radius (r=O-C1=O-C2) being substantially equal to one half of a diameter Dr of the drain recess. Moreover, the radii O-C1 and O-C2 of the sector arc C1-C2 define a sector angle span “2θ” between them at the center O, and the radii O-C1 and O-C2 each define a half angle “θ” at with the major axis X1-X2. Similarly, the sector arc C3-C4 of the first portion 119a comprises a curvature with a radius (r=O-C3=O-C4, not illustrated) being substantially equal to one half of a diameter Dr of the drain recess. Although not illustrated, similar to the sector arc C1-C2, the radii O-C3 and O-C4 of the sector arc C3-C4 define a sector angle span “2θ” between them at the center O, and the radii O-C3 and O-C4 each define a half angle “θ” at with the major axis X1-X2. The sector angle span “2θ” may be the range of about 30 degrees to 150 degrees, 60 degrees to 80 degrees, 68 degrees to 76 degrees, and/or the like.

In some embodiments, the contour of the outer surface 119 of the base projection is defined as a locus of the variable radius “r” about the center O, with limits of:

$$r = \{ \begin{matrix}( D 1 ) / 2 , at ( C 1 to C 2 ) and at ( C 3 to C 4 ) \\ ( D 2 ) / 2 , at Y 1 and Y 2 \end{matrix}$$

In other words, the radius “r” may be constant and equal to one half the major axis length D1 throughout the first portion 119a, i.e., the sector arc C1-C2 and the sector arc C3-C4, and may gradually decrease towards the minor axis such that the radius at points Y1 and Y2 of the minor axis is equal to one half the minor axis length D2, thereby forming an oblong contour that is still capable of being operatively coupled with a circular drain recess.

FIGS. 3A-3D illustrate a fluid control component 120, in accordance with some embodiments of the invention. In particular, FIG. 3A illustrates a perspective view 300A of the flow control component 120, in accordance with some embodiments of the invention. FIG. 3B illustrates a top view 300B of the flow control component illustrated in FIG. 3A, in accordance with some embodiments of the invention. FIG. 3C illustrates a bottom view 300C of the flow control component illustrated in FIG. 3A, in accordance with some embodiments of the invention. FIG. 3D illustrates a sectional detail view 300D (Detail A-A) of the flow control component illustrated in FIG. 3C, in accordance with some embodiments of the invention.

As discussed, the fluid control component structured to be operatively coupled to the fluid receptacle 110. Moreover, the fluid control component is structured for controlling (directing, modifying and/or directing fluid direction and/or fluid velocity) fluid flow into the fluid receptacle through the receptacle opening.

The fluid control component 120 typically defines a first end 211a (also referred to as a top end 211a) and an opposite second end 211b. The fluid control component 120 comprises a fluid guide portion 212 (e.g., a funnel portion) extending between the first end 211a and the second end 211b. Moreover, the fluid guide portion 212 defines an inner surface 222b and an outer surface 222a. The inner surface 222b of the fluid guide portion 212 forms a funnel-shaped or nozzle-shaped aperture structured for controlling fluid flow from the first end 211a of the fluid control component 120, through the funnel-shaped or nozzle-shaped aperture of the fluid guide portion 212 and into the fluid receptacle 110. In some embodiments, the fluid guide portion 212 defines a first circumference length at the first end 211a and a second circumference length at the second end 211b such that the first circumferential length is greater than the second circumference length.

The fluid control component 120 further comprises an outer securing portion 218 extending from the first end 211a. The outer securing portion 218 comprises an outer surface 228a and an inner surface 228b (illustrated by FIGS. 3C-3D). The outer securing portion 218 is typically connected to the fluid guide portion 212 at the first end 211a, such that the outer surface 222a of the fluid guide portion 212 and an inner surface 228b of outer securing portion 218 form a recess 214a therebetween (illustrated by FIG. 3C-3D). Typically, the fluid control component 120 is structured to receive an end portion (e.g., portion proximate the first end 111a) of the fluid receptacle 110 between the fluid guide portion 212 and the outer securing portion 218. Moreover, the outer securing portion 218 defines a lower end 218b, as illustrated. In some embodiments, the lower end 218b is structured to contact and/or be positioned proximate to the step coupling portion 114a of the fluid receptacle 110 when the fluid control component 120 is operatively coupled to the fluid receptacle 110. In some embodiments, the outer securing portion 218 defines a third circumference length at the lower end 218b such that the third circumference length is greater than the second circumference length of the fluid guide portion 212. In some embodiments, the fluid guide portion 212 is structured such that (i) at least a portion of the fluid guide portion 212 is received within the receptacle cavity of the fluid receptacle and (ii) outer securing portion 218 is positioned proximate an outer surface of the fluid receptacle when the fluid control component is operatively coupled to the fluid receptacle.

As illustrated by FIG. 3D, in some embodiments, the recess 214a formed by the outer surface 222a of the fluid guide portion 212 and an inner surface 228b of outer securing portion 218 comprises a groove coupling element 214b and a step element 214c. In some embodiments, the groove coupling element 214b is structured for coupling with the projection coupling portion 114b of the fluid receptacle 110.

As illustrated by FIG. 3A, in some embodiments, the outer securing portion 218 comprises a step coupling element 224 proximate the first end 211a, at the outer surface 228a of the outer securing portion 218. The step coupling element 224 is structured for coupling the fluid control component 120 with the containment system cover 130.

In some embodiments, the fluid control component 120 is manufactured from a flexible material, so as to allow a snap-fit type coupling or an interference fit type coupling with the fluid receptacle 110.

FIGS. 4A-4B illustrate a containment system cover 130, in accordance with some embodiments of the invention. In particular, FIG. 4A illustrates a perspective view 400A of the containment system cover 130, in accordance with some embodiments of the invention. FIG. 4B illustrates a bottom view 400B of the containment system cover illustrated in FIG. 4A, in accordance with some embodiments of the invention. Typically, the containment system cover 130 is structured to be operatively coupled to a first end 211a of the fluid control component 120, e.g., at the step coupling element 224 of the fluid control component 120.

Typically, the containment system cover 130 comprises a planar body having a first surface 311a and an opposite second surface 311b. The containment system cover 130 comprises a circumference projection element 324 at the second surface 311b. Typically, the circumference projection element 324 is structured to be operatively coupled to the step coupling element 224 of the fluid control component 120. Moreover, the containment system cover 130 comprises a handle tab 320.

FIGS. 5A-5B illustrate a fluid container 140, in accordance with some embodiments of the invention. In particular, FIG. 5A illustrates a perspective view 500A of a fluid container 140, in accordance with some embodiments of the invention. FIG. 5B illustrates a top view 500B of the fluid container illustrated in FIG. 5A, in accordance with some embodiments of the invention. Typically, the fluid container 140 comprises a container cavity structured for receiving fluid via a container opening. Moreover, the fluid container 140 is structured to be positioned within the receptacle cavity R of the fluid receptacle 110. In some embodiments the fluid container 140 is disposable.

Typically, the fluid container 140 typically comprises a first end 411a and an opposite second end 411b. Moreover, the receptacle body 422 comprises an outer surface 422a and an opposing inner surface 422b extending between the first end 411a and the second end 411b. The receptacle body 112 comprises an opening 416 at the first end 411a forming a receptacle cavity “C” configured for receiving fluid. The receptacle cavity C is at least partially bounded by the inner surface 422b, as illustrated. In some embodiments, a volume of the container cavity C of the fluid container 140 is lesser than that of the receptacle cavity R of the fluid receptacle 110.

In some embodiments, the fluid container 140 is structured to be secured within the receptacle cavity R of the fluid receptacle 110 based on positioning an end portion (proximate the first end 411a) of the fluid container 140 between the fluid control component 120 and an inner surface 122b of the fluid receptacle 110 when the fluid control component is operatively coupled to the fluid receptacle.

In some embodiments, the fluid container 140 is flexible. Moreover, in some embodiments, the fluid container 140 comprises an interior thermal resistant lining configured for storing and/or transporting heated fluids.

FIGS. 6A-6B illustrate a fluid containment system assembly, in accordance with some embodiments of the invention. In particular, FIG. 6A illustrates a front view 600A of a fluid containment system assembly, in accordance with some embodiments of the invention. FIG. 6B illustrates a top perspective view 600B of a fluid containment system assembly, in accordance with some embodiments of the invention.

FIGS. 6A and 6B together illustrate a method for fluid containment, while FIG. 6C illustrates a corresponding high level process flow for the method for fluid containment. Specifically, FIG. 6A illustrates a method assembly of fluid containment system 10. The fluid container 140 may be positioned within the fluid receptacle 110, as described above. Next, the fluid control component 120 may be positioned over the assembly of the fluid receptacle 110 and the fluid container 140 such that at least portions of the fluid receptacle 110 and the fluid container 140 are positioned within a the recess 214a formed by the outer surface 222a of the fluid guide portion 212 and an inner surface 228b of outer securing portion 218, via the groove coupling element 214b and the step element 214c, described with respect to FIGS. 3C-3D. Additionally, the containment system cover 130 may be coupled with the fluid control component 120.

FIG. 6B illustrates a method of use of fluid containment system 10. The assembled fluid containment system 10, e.g., via the base projection 118/base stabilizer 118 of the fluid receptacle 110 maybe positioned within a drain recess 610, such as a drain portion (e.g., with the base projection 118 being substantially enclosed by and/or received within the drain recess 610, as previously described with respect to FIGS. 2C-2D). The fluid 195 may then be transferred into the fluid container 140 posited within the fluid receptacle 110, via the fluid control component 120.

FIG. 6C illustrates a high level process flow 600C for a method for fluid containment, in accordance with some embodiments of the invention. As illustrated by block 620, the method beings by providing a fluid receptacle (e.g., the fluid receptacle 110, 710, etc.). As discussed above, the fluid receptacle typically comprises a receptacle cavity, a receptacle opening, and a base stabilizer structured for positioning and stabilizing the fluid receptacle within a drain recess. A fluid control component (e.g., fluid control component 120, 720, etc.) structured to be operatively coupled to the fluid receptacle is also provided. As discussed, the fluid control component is structured for controlling fluid flow into the fluid receptacle through the receptacle opening.

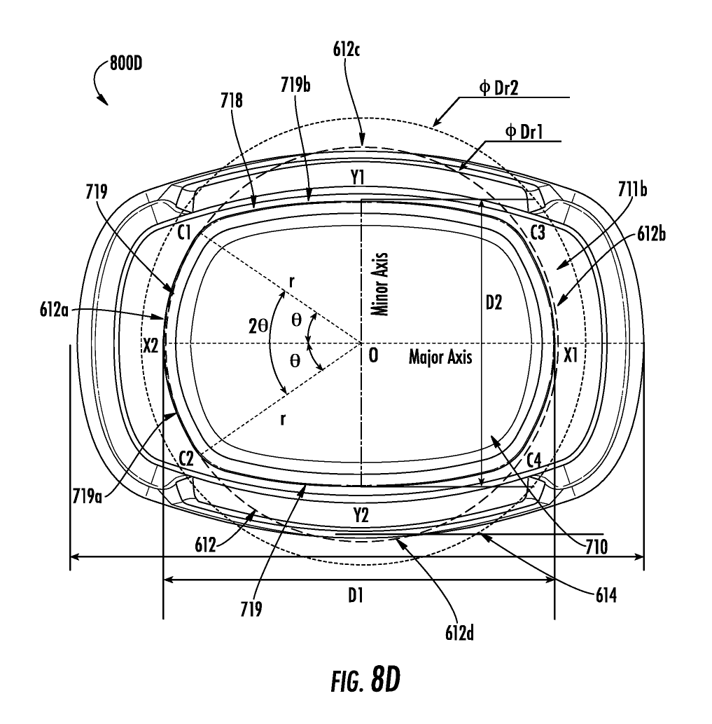

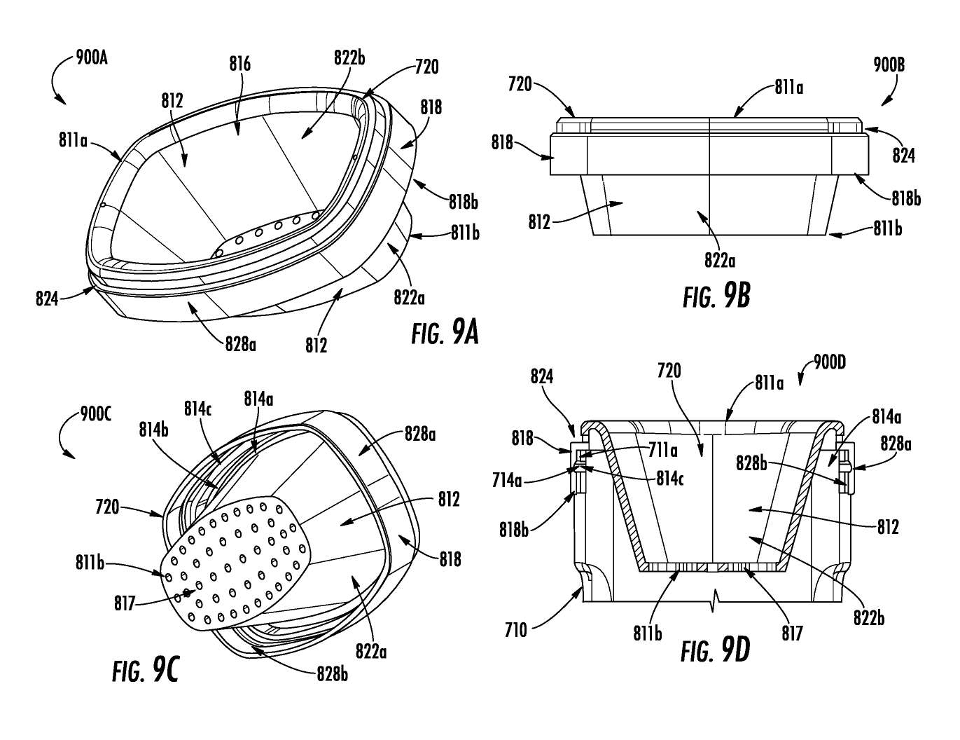

Next, the method involves operatively coupling the fluid control component and the fluid receptacle to form a receptacle assembly, as indicated by block 622 (e.g., as best illustrated by FIGS. 6A and 9D). As discussed, operatively coupling the fluid control component and the fluid receptacle typically comprises positioning an end portion of the fluid receptacle between the fluid guide portion and the outer securing portion such that (i) at least a portion of the fluid guide portion is received within the receptacle cavity of the fluid receptacle, and (ii) the outer securing portion is positioned proximate an outer surface of the fluid receptacle. In some embodiments, optionally, this step may also include securing a fluid container within the receptacle cavity of the fluid receptacle based on positioning an end portion of the fluid container between the fluid guide portion and an inner surface of the fluid receptacle, as illustrated by FIG. 6A.

Next, as indicated by block 624, the method involves positioning the receptacle assembly within at a drain recess (e.g., as illustrated by FIGS. 2D and 6B). As discussed, the receptacle is positioned such that (i) at least a portion of the outer surface of the base projection is enclosed by the drain recess, (ii) a first portion of the outer surface of the base projection operatively contacts an adjacent inner surface of the drain recess, and (iii) a second portion of the outer surface extending from the first portion of the outer surface does not contact an adjacent inner surface of the drain recess. Next, as indicated by block 626, the method involves transferring a fluid into the receptacle cavity of the fluid receptacle through the fluid control component, e.g., as illustrated by FIG. 6B. Moreover, a containment system cover may be coupled to a first end of the fluid control component, as indicated by block 628. Also, the receptacle assembly may then be withdrawn from the drain recess, as indicated by block 630.

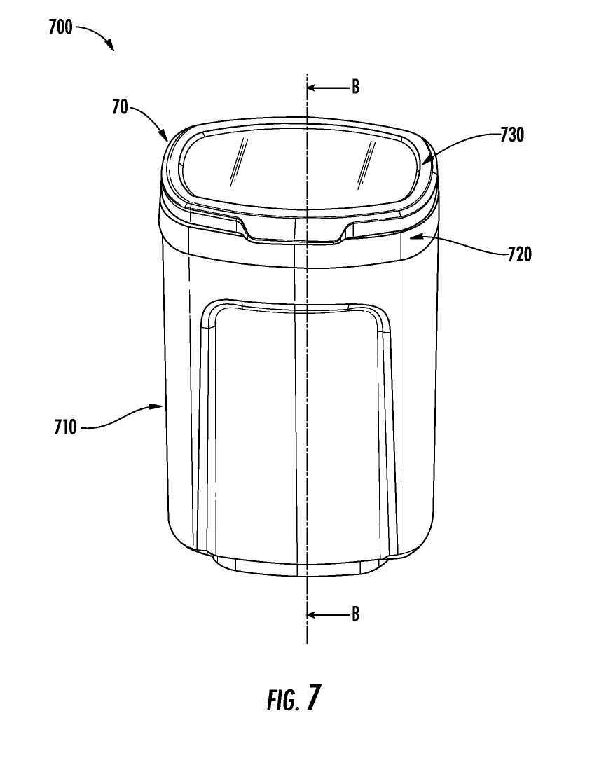

Other embodiments of the fluid containment system will now be described. FIG. 7 illustrates a perspective view 700 of a fluid containment system 70, in accordance with some embodiments of the invention. The fluid containment system 70 is substantially similar to the fluid containment system 10 in structure and/or function, described previously with respect to the embodiments in FIGS. 1-6B. Similar to the fluid containment system 10, the fluid containment system 70 typically comprises a fluid receptacle 710, a flow control component 720 and a containment system cover 730. In some embodiments, the fluid containment system 70 also comprises also comprises the fluid container 140 previously described with respect to FIGS. 5A-5B and 6A-6B. As discussed, the fluid receptacle 710 is typically structured to receive, contain, store and/or transport fluid either directly or via the fluid container 140, similar to the fluid receptacle 110 described in previous embodiments. Moreover, the fluid receptacle 710 is also configured to securely position the fluid containment system 70 within a drain portion in some embodiments. The fluid control component 720 is structured to be operatively coupled to the fluid receptacle 710 and is further structured to control the direction, channel and/or guide flow of fluid into the fluid receptacle 710, similar to the fluid control component 120 described in prior embodiments. Moreover, in some embodiments, the fluid control component 720 is structured to operatively secure or position the fluid container 140 within the fluid receptacle 710. The containment system cover 730 is structured to be operatively coupled to the fluid control component 720 to securely enclose fluid within the fluid receptacle 710, similar to the containment system cover 130 described in prior embodiments. The fluid container 140 is structured to receive, contain, store and/or transport fluid and structured to be positioned within the fluid receptacle 710. The configuration of these components is described below in detail. The fluid containment system 70 can comprise more or fewer components as required for various embodiments. In some embodiments the component of the fluid containment system 70 (710, 720, and/or 730) are interchangeable with or can be substituted for respective components of the fluid containment system 10 (110, 120, and/or 130) to form may more embodiments of fluid containment systems,

One or more of the components (e.g., the fluid receptacle 710, fluid control component 720, and/or containment system cover 730) of the fluid containment system 70 may be manufactured from same or different materials, such as plastics, metals, alloys, composites, non-metals, organic materials, and/or the like, or a combination thereof. In some embodiments, the components of the fluid containment system 70, and particularly the fluid receptacle 710 and/or fluid control component 720, may be manufactured from thermal resistant/heat resistant materials that have the thermal resistance and/or are structured to withstand without deforming (e.g., upon exposure to high temperature fluids), temperatures in the range of about 300° F. to 375° F., 350° F. to 480° F., 350° F. to 400° F., 325° F. to 395° F., 250° F. to 380° F., 150° F. to 380° F., 50° F. to 450° F., 100° F. to 480° F., 250° F. to 480° F., and/or 210° F. to 500° F., including, in-between, or overlapping these ranges, and/or temperatures greater than about 100° F., 130° F., 180° F., 210° F., 250° F., 275° F., 310° F., 320° F., 345° F., 350° F., 370° F., 385° F., 400° F., 450° F., 475° F., 500° F., 530° F., 550° F., 600° F., 670° F., or 700° F. Moreover, these thermal resistant/heat resistant materials may be selected from a group comprising heat resistant plastic materials, heat resistant composites, heat resistant polymers, heat resistant metals/alloys, and/or the like. Also, these thermal resistant/heat resistant materials may be food grade.

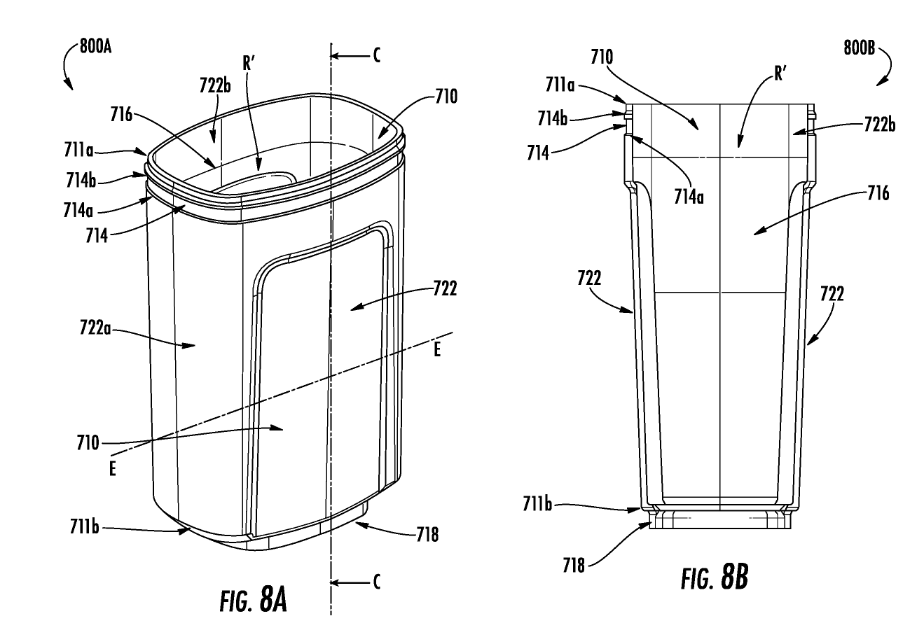

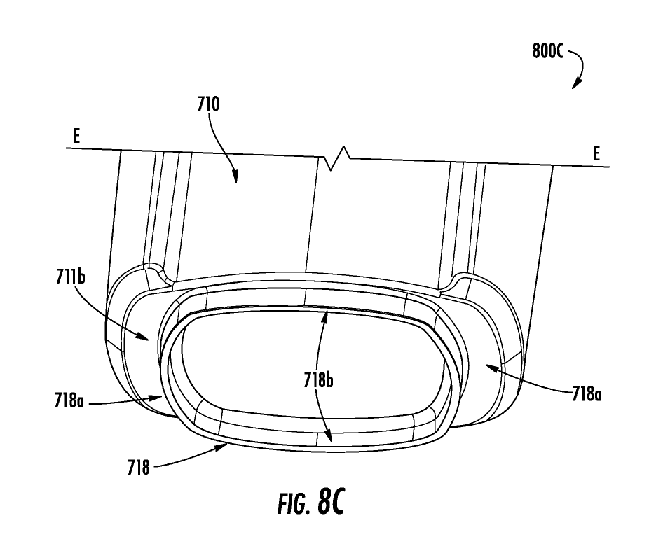

FIGS. 8A-8D illustrate a fluid receptacle 710, in accordance with some embodiments of the invention. In particular, FIG. 8A illustrates a perspective view 800A of a fluid receptacle, in accordance with some embodiments of the invention. FIG. 8B illustrates a side sectional view 800B of the fluid receptacle illustrated in FIG. 8A along section C-C, in accordance with some embodiments of the invention. FIG. 8C illustrates a bottom sectional view 800C of the fluid receptacle illustrated in FIG. 8A along section E-E, in accordance with some embodiments of the invention. FIG. 8D illustrates a schematic bottom view 800D of the fluid receptacle illustrated in FIG. 8A, in accordance with some embodiments of the invention.

The fluid receptacle 710 typically comprises a receptacle body 722 having a first end 711a and an opposite second end 711b, corresponding to substantially respective/like structures of the fluid receptacle 110 described previously with respect to the embodiments of the fluid containment system 10. Moreover, the receptacle body 722 comprises an outer surface 722a and an opposing inner surface 722b extending between the first end 711a and the second end 711b. The receptacle body 722 comprises an opening 716 at the first end 711a forming a receptacle cavity R′ configured for receiving fluid either directly, receiving fluid within a fluid container 140 and or receiving the fluid container. The receptacle cavity R is at least partially bounded by the inner surface 722b, as illustrated. The receptacle body 722 comprises a receptacle coupling portion 714 proximate the first end 711a. The receptacle coupling portion 714 comprises one or more coupling elements for coupling the fluid receptacle 710 with the fluid control component 720. The one or more coupling elements of the receptacle coupling portion 714 comprise a step coupling portion 714a and a projection coupling portion 714b positioned on the outer surface 722a of the fluid receptacle 710.

The fluid receptacle 710 further comprises a base projection 718 (also referred to as a base stabilizer 718) at the second end 711b, as illustrated by FIGS. 8A and 8C-8D. The base projection 718 is structured to position and stabilize the fluid receptacle 710 within a recess, such as a drain portion 610 (illustrated in FIG. 6B). Specifically, in some embodiments, the base projection 718 comprises a outer surface 719 with one or more curved portions 719a having curvature corresponding to, and/or compatible with a curvature of the recess. In some embodiments the one or more curved portions 718a comprise a curvature of a section of a circle. In some embodiments, typically, the base projection 718 comprises two opposite curved portions 719a, as illustrated by FIGS. 8C-8D. Here, in some embodiments, the base projection 718 may further comprise one or more bridge portions 719b extending between the opposite curved portions 719a, as illustrated.

The structure of the base projection 718, vis-à-vis the operatively coupling of the fluid receptacle 710 and a drain recess 610, particularly with respect to FIG. 8D. The base projection 718 is substantially similar the base projection 118 previously described with respect to FIGS. 2C-2D. As discussed, the drain recess 610 (illustrated in FIG. 6B) may define an inner surface, typically a circular inner surface 612 having a diameter “Dr1,” as illustrated by FIG. 8D. In this regard, the circular inner surface 612 illustrated by FIG. 8D may be associated with a cross section (e.g., a cross section along a plane perpendicular to the axis) of the drain recess 610, with the drain recess 610 in turn generally having a cylindrical shape, conical shape, a stepped-cylindrical shape, or a combination of the foregoing, at least in part.

As discussed above, the base projection 718 of the fluid receptacle 710 extends from the second end 711b. Typically, when the fluid receptacle 710 is positioned at the drain recess 610, the at least a portion of the outer surface 719 of the base projection 718 is enclosed by the inner surface 612 of the drain recess 610. Moreover, in the embodiment illustrated in FIG. 8D, the outer surface 719 of the base projection 718 is fully enclosed by the inner surface 612 of the drain recess 610 (e.g., when viewed at a cross section along a plane perpendicular to a longitudinal axis of the fluid receptacle 710).

Now referring to FIG. 8D, the base projection 718 typically defines a major axis X1-X2, and a minor axis Y1-Y2 perpendicular to and intersecting the major axis X1-X2 at a center “0”. Typically, the major axis X1-X2 is located at a maxima of the width of the outer surface 719 (e.g., perpendicular distance between points X1 and X2) along the minor axis Y1-Y2, and the minor axis Y1-Y2 is located at a maxima of the thickness of the outer surface 719 (e.g., perpendicular distance between points Y1 and Y2) along the major axis X1-X2. In other words, the major axis X1-X2 defines a maximum width D1 or major axis length D1, and the minor axis defines a maximum thickness D2 or minor axis length D2. Moreover, the major axis length D1 is typically greater than the minor axis length D2.

As illustrated by FIG. 8D, the base projection 718 comprises a first portion 719a that operatively contacts an adjacent portion of the inner surface 612 of the drain recess 610, and a second portion 719b that does not contact an adjacent portion of the inner surface 612. Specifically, the first portion 719a comprising sector arc C1-C2 operatively contacts an adjacent portion 612a of the inner surface 612, while the second portion 719b comprising sector arc C1-C3 does not contact the adjacent portion 612c of the inner surface 612. Similarly, the first portion 719a comprising sector arc C3-C4 operatively contacts an adjacent portion 612b of the inner surface 612, while the second portion 719b comprising sector arc C2-C4 does not contact the adjacent portion 612d of the inner surface 612. As such, the first portion 719a may refer to one or both of the sector arcs C1-C2 and C3-C4, while the second portion 719b may in turn refer to one or both of the sector arcs C1-C3 and C2-C4. That said, it is understood that the first portion 719a and/or the second portion 719b may comprise more or fewer arc sectors each (e.g., 3 or 5 arc sectors each) in other embodiments. Moreover, “operative contact” as used herein may refer to substantial contact (e.g., accounting for tolerances, surface texture, roughness, surface defects, surface patterns, and/or the like) between the first portion 719a and the corresponding adjacent portion of the inner surface 612 such that the base projection 718 positions (i.e., anchors) and stabilizes the fluid receptacle 710 within the drain recess 610 (e.g., in a stable upright manner as illustrated in FIG. 6B). In addition, in some embodiments, “operative contact” may refer to an interference fit (e.g., press fit, etc.) between the first portion 719a and the corresponding adjacent portion of the inner surface 612, while in other embodiments “operative contact” may refer to either a transition fit (e.g., fixed fit, similar fit, tight fit, etc.) or a clearance fit (e.g., location fit, etc.) between the first portion 719a and the corresponding adjacent portion of the inner surface 612, with the first portion 719a being shaped and dimensioned accordingly to provide the corresponding fits.

To facilitate the operative contact, the major axis length D1 at the first portion 719a (i.e., that contacts the inner drain surface 612) is typically substantially equal to the diameter “Dr1” of the inner drain surface 612 of the drain recess 610. Here, “substantially equal” may refer to the major axis length D1 and the diameter “Dr1” of the inner drain surface 612 being about the same (e.g., the nominal value of the major axis length D1 being equal to the nominal value of the diameter “Dr1”), accounting for (i) allowances of the major axis length D1 to provide the desired engineering fit (selected from those listed above) and (ii) tolerances, surface texture, roughness, surface defects, surface pattern and other surface factors of the outer surface 719. In some embodiments, the major axis length D1 may be in the range of about 1.5 inches to 4.5 inches, 1.2 inches to 4.5 inches, 2 inches to 4.5 inches, 2.5 inches to 5.5 inches, 2.5 inches to 4 inches, 2.8 inches to 3.8 inches, and/or the like. Moreover, depending of the type and properties of the engineering fit chosen, the allowances of the major axis length D1 may be in the range of about ±1 mm, ±2 mm, ±3 mm, ±4 mm, ±5 mm, ±6 mm, ±9 mm, and/or the like. Moreover, the minor axis length D2 at the second portion 719b of the outer surface 719 is typically less than the diameter “Dr1” of the inner drain surface 612 of the drain recess 610. In particular, the minor axis length D2 may be in the range of about 1 inch to 3 inches, 1.2 inches to 4 inches, 2 inches to 4.5 inches, 2.5 inches to 5 inches, 2.5 inches to 3.5 inches, 2.8 inches to 3.2 inches, and/or the like, with the minor axis length D2 being less than the major axis length D2.

Moreover, the first portion 719a comprises a first curvature that matches a curvature of an adjacent inner surface of the drain recess when the base projection is positioned within the drain recess. In this regard, the sector arc C1-C2 of the first portion 719a comprises a curvature with a radius (r=O-C1=O-C2) being substantially equal to one half of a diameter Dr1 of the drain recess. Moreover, the radii O-C1 and O-C2 of the sector arc C1-C2 define a sector angle span “2θ” between them at the center O, and the radii O-C1 and O-C2 each define a half angle “e” at with the major axis X1-X2. Similarly, the sector arc C3-C4 of the first portion 719a comprises a curvature with a radius (r=O-C3=0-C4, not illustrated) being substantially equal to one half of a diameter Dr1 of the drain recess. Although not illustrated, similar to the sector arc C1-C2, the radii O-C3 and O-C4 of the sector arc C3-C4 define a sector angle span “2θ” between them at the center O, and the radii O-C3 and O-C4 each define a half angle “e” at with the major axis X1-X2. The sector angle span “2θ” may be the range of about 30 degrees to 150 degrees, 60 degrees to 80 degrees, 68 degrees to 76 degrees, and/or the like.

In some embodiments, the contour of the outer surface 719 of the base projection is defined as a locus of the variable radius “r” about the center O, with limits of:

$$r = \{ \begin{matrix}( D 1 ) / 2 , at ( C 1 to C 2 ) and at ( C 3 to C 4 ) \\ ( D 2 ) / 2 , at Y 1 and Y 2 \end{matrix}$$

In other words, the radius “r” may be constant and equal to one half the major axis length D1 throughout the first portion 719a, i.e., the sector arc C1-C2 and the sector arc C3-C4, and may gradually decrease towards the minor axis such that the radius at points Y1 and Y2 of the minor axis is equal to one half the minor axis length D2, thereby forming an oblong contour that is still capable of being operatively coupled with a circular drain recess.

Moreover, FIG. 8D illustrates another second drain recess 614 having a diameter Dr2 that is greater than diameter Dr1 of drain recess 612 and greater than the major axis length D1. Even though the diameter Dr2 of the second drain recess 614 is greater than the major axis length D1, it is contemplated that in such embodiments, the fluid receptacle 710 may be positioned in the second drain recess 614 such that the fluid receptacle 710 rests on the drain recess via the second end 711b, as illustrated.

FIGS. 9A-9D illustrate a fluid control component 720, in accordance with some embodiments of the invention. The fluid control component 720 is substantially similar to the fluid control component 120 described with respect to the embodiments of fluid containment system 10 in structure and/or function. In particular, FIG. 9A illustrates a top perspective view 900A of a flow control component, in accordance with some embodiments of the invention. FIG. 9B illustrates a front view 900B of the flow control component illustrated in FIG. 9A, in accordance with some embodiments of the invention. FIG. 9C illustrates a bottom perspective view 900C of the flow control component illustrated in FIG. 9A, in accordance with some embodiments of the invention. FIG. 9D illustrates a sectional detail view 900D of an assembly of the flow control component illustrated in FIG. 9A and the fluid receptacle illustrated in FIG. 8A, in accordance with some embodiments of the invention.

As discussed, the fluid control component structured to be operatively coupled to the fluid receptacle 710. Moreover, the fluid control component is structured for controlling (directing, modifying and/or directing fluid direction and/or fluid velocity) fluid flow into the fluid receptacle through the receptacle opening.

The fluid control component 720 typically defines a first end 811a (also referred to as a top end 811a) and an opposite second end 811b. The fluid control component 720 comprises a fluid guide portion 812 (e.g., a funnel portion) extending between the first end 811a and the second end 811b. Moreover, the fluid guide portion 812 defines an inner surface 822b and an outer surface 822a. The inner surface 822b of the fluid guide portion 812 forms a funnel-shaped or nozzle-shaped aperture structured for controlling fluid flow from the first end 811a of the fluid control component 720, through the funnel-shaped or nozzle-shaped aperture of the fluid guide portion 812 and into the fluid receptacle 710. In some embodiments, the fluid guide portion 812 defines a first circumference/perimeter length at the first end 811a and a second circumference/perimeter length at the second end 811b such that the first circumferential length is greater than the second circumference length, as illustrated.

The fluid control component 720 further comprises an outer securing portion 818 extending from the first end 811a. The outer securing portion 818 comprises an outer surface 828a and an inner surface 828b (best illustrated by FIGS. 9C-9D). The outer securing portion 818 is typically connected to the fluid guide portion 812 at the first end 811a, such that the outer surface 822a of the fluid guide portion 812 and an inner surface 828b of outer securing portion 818 form a recess 814a therebetween (best illustrated by FIGS. 9C-9D). Typically, the fluid control component 720 is structured to receive an end portion (e.g., portion proximate the first end 711a) of the fluid receptacle 710 between the fluid guide portion 812 and the outer securing portion 818, best illustrated by FIG. 9D. Moreover, the outer securing portion 818 defines a lower end 818b, as illustrated. In some embodiments, the lower end 818b is structured to contact and/or be positioned proximate to the step coupling portion 714a of the fluid receptacle 710 when the fluid control component 720 is operatively coupled to the fluid receptacle 710. In some embodiments, the outer securing portion 818 defines a third circumference length at the lower end 818b such that the third circumference/perimeter length is greater than the second perimeter/circumference length of the fluid guide portion 812.

Moreover, in the embodiments of fluid control component 720 illustrated in FIGS. 9A-9D, the fluid control component 720 further comprises filtering capability. Here, the fluid control component 720 may comprise a filter structure 817 terminating the fluid guide portion 812 at the lower end 818b. Typically, this filter structure 817 comprises a plurality of apertures structured for (i) allowing flow of substances of sizes lesser than a predetermined size therethrough (e.g., fluids, particulates of size smaller than the predetermined size, etc.) and for (ii) blocking flow of substances of sizes greater than the predetermined size (e.g., particulates/solids of sizes greater than the predetermined size, etc.). Moreover, the filter structure 817 may comprise a planar shape, a curved shape or a combination of the two.

In some embodiments, the fluid guide portion 812 is structured such that (i) at least a portion of the fluid guide portion 812 is received within the receptacle cavity of the fluid receptacle and (ii) outer securing portion 818 is positioned proximate an outer surface of or external to the fluid receptacle 710 when the fluid control component is operatively coupled to the fluid receptacle.

As illustrated by FIGS. 9C-9D, in some embodiments, the recess 814a formed by the outer surface 822a of the fluid guide portion 812 and an inner surface 828b of outer securing portion 818 comprises a groove coupling element 814b and a step element 814c. In some embodiments, the groove coupling element 814b is structured for coupling with the projection coupling portion 714b of the fluid receptacle 710, as best illustrated by FIG. 9D.

As best illustrated by FIGS. 9A, 9C-9D, in some embodiments, the outer securing portion 818 comprises a step coupling element 824 proximate the first end 811a, at the outer surface 828a of the outer securing portion 818. The step coupling element 824 is structured for coupling the fluid control component 720 with the containment system cover 730.

In some embodiments, the fluid control component 720 is manufactured from a flexible material (e.g., a flexible thermal resistant plastic), so as to allow a snap-fit type coupling or an interference fit type coupling with the fluid receptacle 710.

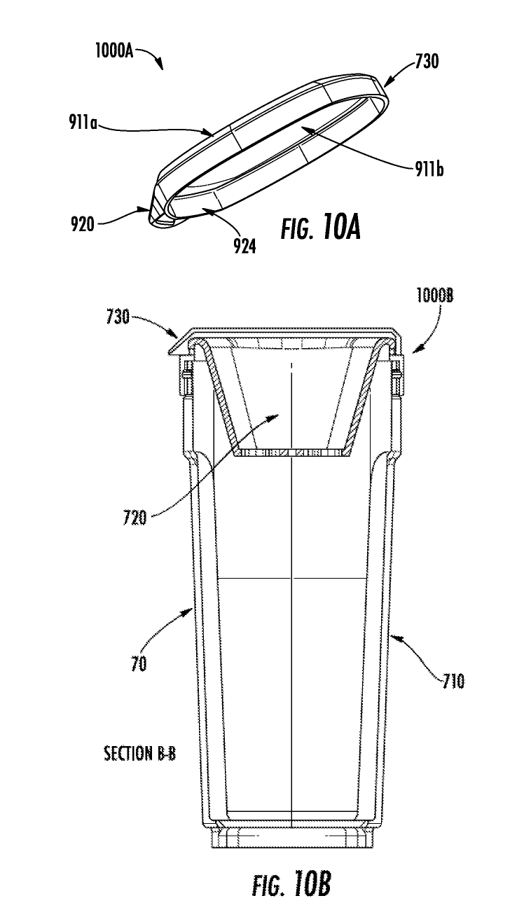

FIG. 10A illustrates a containment system cover 730, in accordance with some embodiments of the invention. In particular, FIG. 10A illustrates a perspective view 1000A of the containment system cover 730, in accordance with some embodiments of the invention. Typically, the containment system cover 730 is structured to be operatively coupled to a first end 811a of the fluid control component 720, e.g., at the step coupling element 824 of the fluid control component 720. Typically, the containment system cover 730 comprises a planar body having a first surface 911a and an opposite second surface 911b. The containment system cover 730 comprises a circumference projection element 924 at the second surface 911b. Typically, the circumference projection element 924 is structured to be operatively coupled to the step coupling element 824 of the fluid control component 720. Moreover, the containment system cover 730 comprises a handle tab 920.

FIG. 10B illustrates a sectional view 1000B of the fluid containment system assembly illustrated in FIG. 7 along section B-B, in accordance with some embodiments of the invention. In particular, FIG. 10B illustrates the assembly of the fluid receptacle 710, the fluid control component 720, and the containment system cover 730 to form the fluid containment system 70. Although not illustrated by FIG. 10B, in some embodiments, the fluid containment system 70 may further comprise the fluid container 140 as illustrated and described with respect to FIGS. 5A-5B previously.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation. In addition, where possible, any terms expressed in the singular form herein are meant to also include the plural form and/or vice versa. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein.

What is claimed:

1. A fluid containment system, comprising:
a fluid receptacle comprising:
a receptacle cavity;
a receptacle opening at a first end of the fluid receptacle, wherein the fluid receptacle is structured for receiving fluid into the receptacle cavity via the receptacle opening; and
a base projection extending from a second end of the fluid receptacle structured for positioning and stabilizing the fluid receptacle within a drain recess such that at least a portion of an outer surface of the base projection is configured to be enclosed by the drain recess; and
a fluid control component structured to be operatively coupled to the fluid receptacle, wherein the fluid control component is structured for controlling fluid flow into the fluid receptacle through the receptacle opening.

2. The fluid containment system of claim 1, wherein the base projection is configured such that when the base projection is positioned in the drain recess:
a first portion of the outer surface of the base projection is configured to operatively contact an adjacent inner surface of the drain recess; and
a second portion of the outer surface extending from the first portion of the outer surface is configured to not contact an adjacent inner surface of the drain recess.

3. The fluid containment system of claim 1, wherein:
the base projection defines a major axis length at a first portion of the outer surface such that the major axis length is substantially equal to a diameter of the drain recess; and
the base projection defines a minor axis length at a second portion of the outer surface such that the minor axis length is less than the diameter of the drain recess.

4. The fluid containment system of claim 3, wherein the major axis length and the diameter of the drain recess are in a range of 1.5 inches to 4.5 inches.

5. The fluid containment system of claim 1, wherein a first portion of the outer surface of the base projection comprises a first curvature that matches a curvature of an adjacent inner surface of the drain recess when the base projection is positioned within the drain recess, wherein a radius of the first curvature is substantially equal to one half of a diameter of the drain recess.

6. The fluid containment system of claim 5, wherein the first portion of the outer surface defines a sector angle span in a range of 30 degrees to 150 degrees.

7. The fluid containment system of claim 5, wherein the first portion of the outer surface defines a sector angle span in a range of 60 degrees to 80 degrees.

8. The fluid containment system of claim 1, further comprising:
a containment system cover structured to be operatively coupled to a first end of the fluid control component.

9. The fluid containment system of claim 1, further comprising:
a fluid container comprising a container cavity structured for receiving fluid via a container opening; and
wherein the fluid container is structured to be positioned within the receptacle cavity of the fluid receptacle.

10. The fluid containment system of claim 9, wherein the container cavity of the fluid container comprises a lesser volume than the receptacle cavity of the fluid receptacle.

11. The fluid containment system of claim 1, wherein the fluid control component defines a first end and an opposite second end, wherein the fluid control component further comprises:
a fluid guide portion extending between the first end and the second end; and
an outer securing portion extending from the first end; and
wherein the fluid control component is structured to receive an end portion of the fluid receptacle between the fluid guide portion and the outer securing portion, wherein the end portion is proximate the receptacle opening of the fluid receptacle.

12. The fluid containment system of claim 11, wherein:
the fluid guide portion defines a first circumference length at the first end and a second circumference length at the second end such that the first circumference length is greater than the second circumference length, wherein the first end is a top end;
the outer securing portion defines a third circumference length at a lower end such that the third circumference length is greater than the second circumference length; and
the fluid guide portion is structured such that (i) at least a portion of the fluid guide portion is received within the receptacle cavity of the fluid receptacle and (ii) the outer securing portion is positioned proximate an outer surface of the fluid receptacle when the fluid control component is operatively coupled to the fluid receptacle.

13. The fluid containment system of claim 11, wherein:
the fluid guide portion is structured to secure a fluid container within the receptacle cavity of the fluid receptacle based on positioning an end portion of the fluid container between the fluid guide portion and an inner surface of the fluid receptacle when the fluid control component is operatively coupled to the fluid receptacle.

14. The fluid containment system of claim 13, wherein the fluid container is flexible.

15. The fluid containment system of claim 1, wherein the fluid control component comprises a filter structure.

16. A method for fluid containment, the method comprising:
providing a fluid receptacle, wherein the fluid receptacle comprises a receptacle cavity, a receptacle opening, and a base projection structured for positioning and stabilizing the fluid receptacle within a drain recess;
providing a fluid control component structured to be operatively coupled to the fluid receptacle, wherein the fluid control component is structured for controlling fluid flow into the fluid receptacle through the receptacle opening;
operatively coupling the fluid control component and the fluid receptacle to form a receptacle assembly;
positioning the receptacle assembly at the drain recess such that at least a portion of an outer surface of the base projection is configured to be enclosed by the drain recess;
transferring a fluid into the receptacle cavity of the fluid receptacle through the fluid control component; and
operatively coupling a containment system cover to a first end of the fluid control component.

17. The method of claim 16, positioning the receptacle assembly at the drain recess further comprises:
positioning a first portion of the outer surface of the base projection to operatively contact an adjacent inner surface of the drain recess; and
positioning a second portion of the outer surface extending from the first portion of the outer surface to not contact an adjacent inner surface of the drain recess.

18. The method of claim 16, wherein the fluid control component comprises a fluid guide portion extending between the first end and an opposite second end, and an outer securing portion extending from the first end, wherein operatively coupling the fluid control component and the fluid receptacle further comprises:
positioning an end portion of the fluid receptacle between the fluid guide portion and the outer securing portion such that (i) at least a portion of the fluid guide portion is received within the receptacle cavity of the fluid receptacle, and (ii) the outer securing portion is positioned proximate an outer surface of the fluid receptacle.

19. The method of claim 18, further comprising securing a fluid container within the receptacle cavity of the fluid receptacle based on positioning an end portion of the fluid container between the fluid guide portion and an inner surface of the fluid receptacle.

20. A fluid containment system, comprising:
a fluid receptacle comprising:
a receptacle cavity;
a receptacle opening at a first end of the fluid receptacle, wherein the fluid receptacle is structured for receiving fluid into the receptacle cavity via the receptacle opening; and
a base projection structured for positioning and stabilizing the fluid receptacle within the drain recess such that: (i) at least a portion of an outer surface of the base projection is configured to be enclosed by the drain recess, (ii) a first portion of the outer surface of the base projection is configured to operatively contact an adjacent inner surface of the drain recess, and (iii) a second portion of the outer surface extending from the first portion of the outer surface is configured to not contact an adjacent inner surface of the drain recess;
a fluid control component structured to be operatively coupled to the fluid receptacle, wherein the fluid control component is structured for controlling fluid flow into the fluid receptacle through the receptacle opening; and
a containment system cover structured to be operatively coupled to a first end of the fluid control component.
